(19) United States
(12) Patent Application Publication
(10) Pub. No.: US 2025/0345951 A1
(43) Pub. Date: Nov. 13, 2025

(54) FLOOR MOVING SYSTEM

(71) Applicant: Weidong LI, Xinji City (CN)

(72) Inventor: Weidong LI, Xinji City (CN)

(73) Assignee: HEBEI SNDAS SURVEY AND DRAW CO., LTD., Xingtai City (CN)

(21) Appl. No.: 19/274,629

(22) Filed: Jul. 20, 2025

(51) Int. Cl. B25J 15/06

(52) U.S. Cl. CPC B25J 15/0683

(57) ABSTRACT

The present invention discloses a floor moving system for moving floors. When the upper surface of the floor is too rough for the suction cups to adhere, the system includes a tape and a suction device. The lower surface of the tape is an adhesive surface used to bond to the upper surface of the floor, and the upper surface of the tape is a suction surface. The suction device is equipped with suction cups that adhere to the upper surface of the tape. When the suction device is subjected to force, it drives the tape and the floor bonded to the tape to move.

### TECHNICAL FIELD

The present invention relates to the field of floor installation and maintenance tools, and particularly to a floor moving system.

### BACKGROUND OF THE INVENTION

During the installation and use of floors, gaps often occur between floor panels due to a variety of reasons, including improper installation caused by non-standard operations of installers, deformation triggered by changes in temperature and humidity in the environment, and normal wear and tear from long-term use. These gaps not only affect the aesthetic appearance of the floor but can also lead to dust accumulation, bacterial growth, and even pose a threat to the structural stability of the floor.

Existing floor repair tools on the market, although aimed at solving this problem, all have certain drawbacks. Some tools require inserting the device into the gaps between floor panels and then using a hammer to strike the tool to move the floor back into place. However, the striking force of the hammer is difficult to precisely control, which can easily damage the surface of the floor, affecting its appearance and service life. Additionally, inserting the tool into narrow floor gaps can also cause damage to the floor. Other repair tools involve attaching suction cups to the floor and moving the floor by shifting the suction cups. However, this method is only suitable for floors with smooth surfaces. If the floor surface is rough, textured, or uneven, the suction cups struggle to adhere stably, making it impossible to move the floor effectively.

To address these issues, the present invention provides a floor moving system that effectively solves the aforementioned problems. It features a simple structure and convenient use, involving attaching tape to the floor surface and adhering the suction cups to the tape, thereby moving the floor by driving the suction cups.

### SUMMARY OF THE INVENTION

To overcome the shortcomings of existing technologies, the present invention provides a floor moving system that is simple in structure, easy to use, and highly adaptable.

The technical solution adopted by the present invention to solve the technical problem is as follows:

A floor moving system for moving floors, wherein the upper surface of the floor is too rough for the suction cup to adhere, including:

Tape, the lower surface of which is an adhesive surface for bonding to the upper surface of the floor, and the upper surface of which is a suction surface;

Suction device, which comprises a suction cup that adheres to the upper surface of the tape, and when the suction device is subjected to force, it drives the tape and the floor bonded to the tape to move.

The beneficial effects of the present invention are as follows: With the above structure, during use, the tape is bonded to the upper surface of the floor, and the suction cup of the suction device is adhered to the suction surface of the tape. By moving the suction device, the suction cup, tape, and the floor bonded to the tape are moved, thereby allowing users to adjust the position of the floor and eliminate gaps between floor panels. The use of tape can modify the surface of the floor, enabling users to employ a suction device with suction cups to move the floor, thereby enhancing the adaptability of the suction device. It can be applied to floors with various surface characteristics, making it convenient for users to adjust the position of the floor. The system is simple to use.

### BRIEF DESCRIPTION OF DRAWINGS

To more clearly illustrate the technical solution of the embodiments of the present invention, the following is a brief introduction to the drawings used in the description of the embodiments. The drawings described below are merely some embodiments of the present invention. For those of ordinary skill in the art, other drawings can be obtained from these drawings without creative effort.

The invention will be further described below in conjunction with the drawings and embodiments.

FIG. 1 is a schematic diagram of the use of the floor moving system according to the present invention;

FIG. 2 is a sectional view of the system in the operating state according to the present invention;

FIG. 3 is a sectional view of the tape according to the present invention;

FIG. 4 is a force-displacement curve of the 90° peel strength test of the tape according to the present invention;

FIG. 5 is an overall structural diagram of the suction device at an angle when the eccentric handle is in the release position according to the present invention;

FIG. 6 is an overall structural diagram of the suction device at another angle when the eccentric handle is in the release position according to the present invention;

FIG. 7 is a sectional view of the suction device when the eccentric handle is in the release position according to the present invention;

FIG. 8 is an overall structural diagram of the suction device at an angle when the eccentric handle is in the suction position according to the present invention;

FIG. 9 is an overall structural diagram of the suction device at another angle when the eccentric handle is in the suction position according to the present invention;

FIG. 10 is a sectional view of the suction device when the eccentric handle is in the suction position according to the present invention;

FIG. 11 is an overall structural diagram of the suction device at an angle after the extension component is assembled according to the present invention;

FIG. 12 is an overall structural diagram of the suction device at another angle after the extension component is assembled according to the present invention;

FIG. 13 is a sectional view of the suction device after the extension component is assembled according to the present invention;

FIG. 14 is an overall structural diagram of the extension component according to the present invention;

FIG. 15 is an exploded structural diagram of the suction device according to the present invention;

FIG. 16 is a schematic diagram of the operating state according to the present invention;

FIG. 17 is a schematic diagram of the operating state after the extension component is assembled according to the present invention.

### DETAILED DESCRIPTION OF THE INVENTION

To make the objectives, features, and advantages of the present application clearer and more understandable, the specific implementation methods of the present application are described in detail below in conjunction with the accompanying drawings. Many specific details are described in the following description to fully understand the present application. However, the present application can be implemented in many ways other than those described here. Professionals in the field can make similar improvements without departing from the connotations of the present application. Therefore, the present application is not limited to the specific embodiments disclosed below.

In the description of the present application, it should be understood that if terms such as “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” etc., appear, these terms indicate directions or positional relationships based on the directions or positional relationships shown in the accompanying drawings. They are used only to facilitate the description of the present application and simplify the description, rather than to indicate or imply that the device or element must have a specific orientation, be constructed and operate in a specific orientation. Therefore, these terms should not be understood as limitations to the present application.

In addition, if terms such as “first” and “second” appear, these terms are used only for descriptive purposes and should not be understood as indicating or implying relative importance or implicitly indicating the quantity of the technical features indicated. Therefore, features defined by “first” and “second” may explicitly or implicitly include at least one of these features. In the description of the present application, if the term “multiple” appears, “multiple” means at least two, such as two, three, etc., unless otherwise specifically defined.

In the present application, unless otherwise clearly defined and limited, if terms such as “install,” “connect,” “connect,” “fix,” etc., appear, these terms should be understood broadly. For example, they can be fixed connections, detachable connections, or integrated; they can be mechanical connections or electrical connections; they can be direct connections or indirect connections through intermediate media, or they can be the interconnection or interaction relationship between two elements' interiors, unless otherwise specifically defined. For ordinary technical personnel in the field, the specific meanings of the above terms in the present application can be understood according to the specific situation.

In the present application, unless otherwise clearly defined and limited, if the first feature is described as being “above” or “below” the second feature, it means that the first and second features can be in direct contact, or they can be in indirect contact through intermediate media. Moreover, the first feature being “above,” “on top of,” or “over” the second feature may mean that the first feature is directly above or diagonally above the second feature, or it may simply indicate that the first feature is at a higher horizontal level than the second feature. Similarly, the first feature being “below,” “underneath,” or “beneath” the second feature may mean that the first feature is directly below or diagonally below the second feature, or it may simply indicate that the first feature is at a lower horizontal level than the second feature.

It should be noted that if a component is referred to as being “fixed to” or “mounted on” another component, it can be directly on the other component or there may be an intermediate component. If a component is considered to be “connected” to another component, it can be directly connected or indirectly connected through an intermediate component. The terms “vertical,” “horizontal,” “upper,” “lower,” “left,” “right,” and similar expressions used in the present application are for illustrative purposes only and do not represent the only possible implementations.

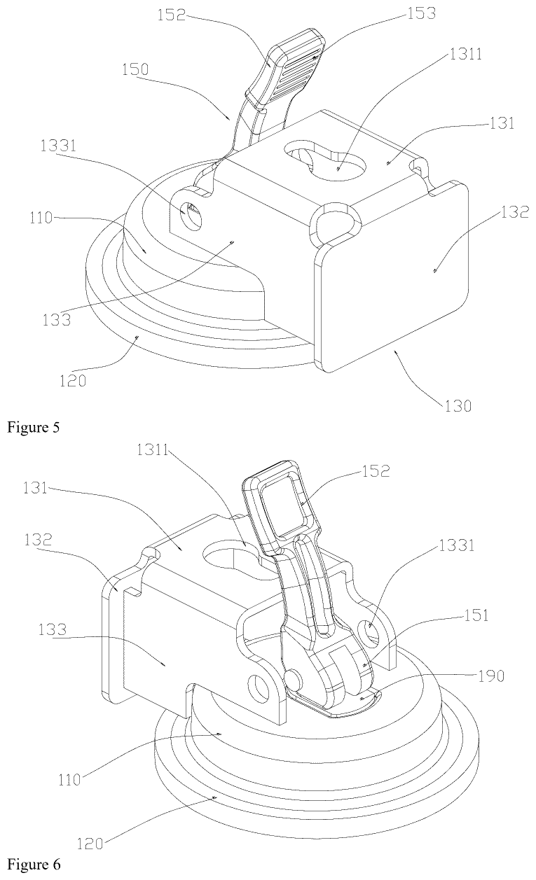

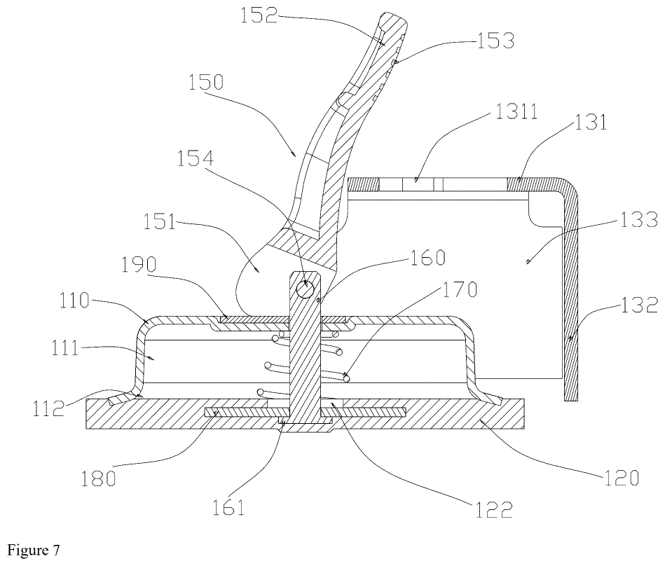

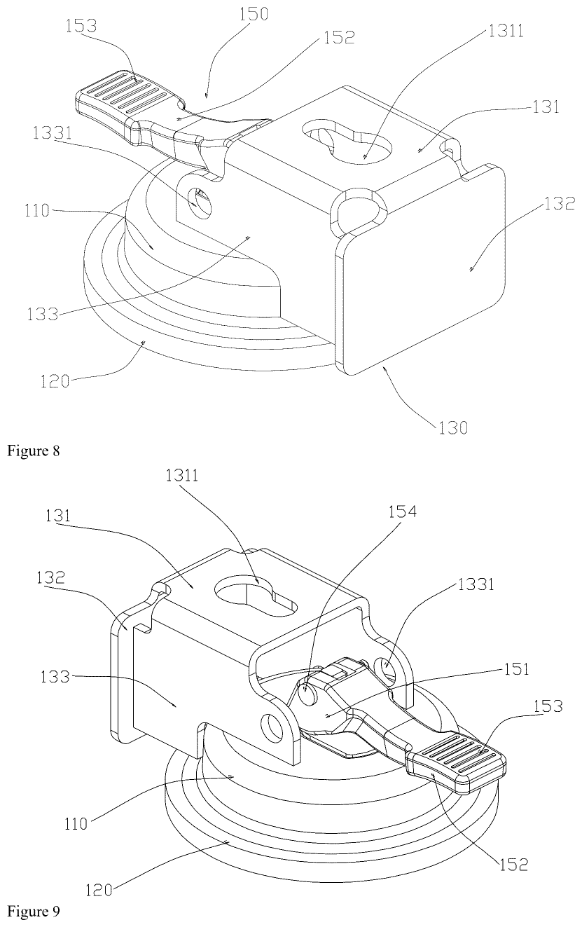

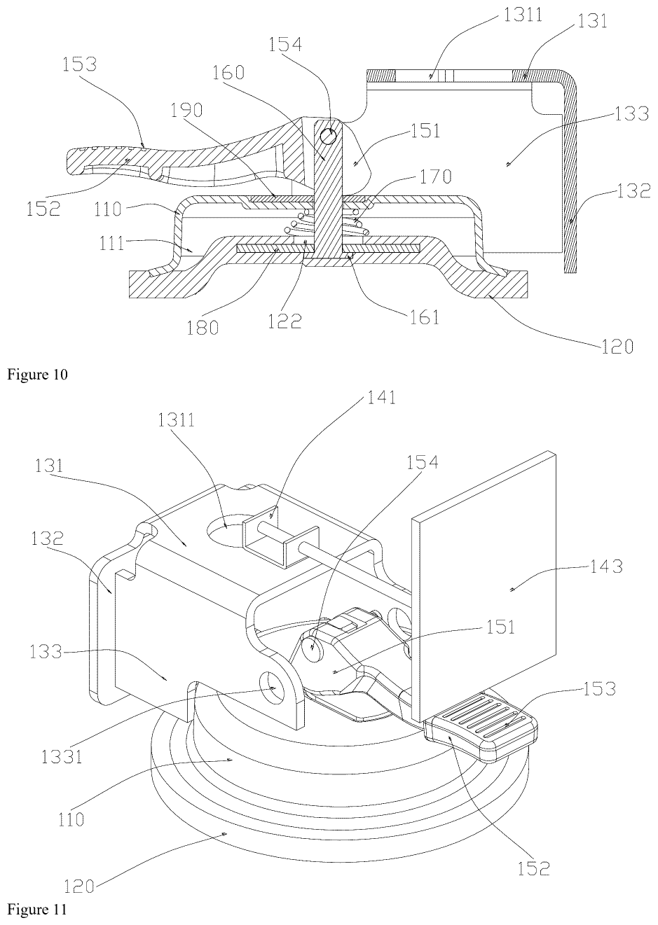

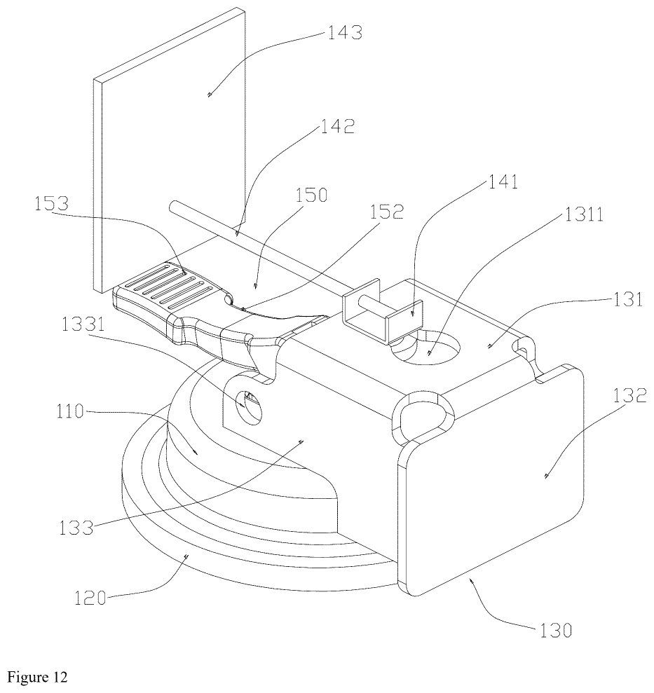

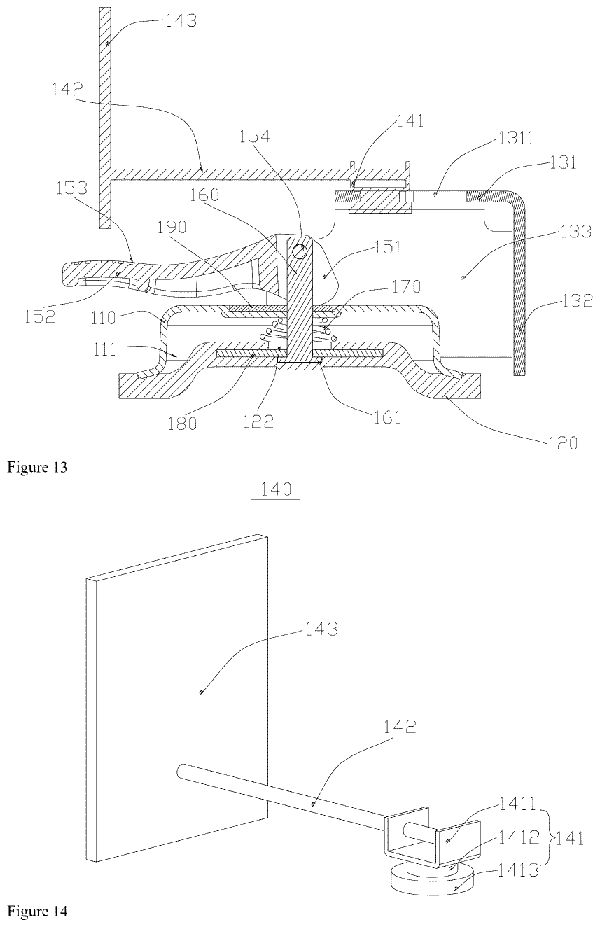

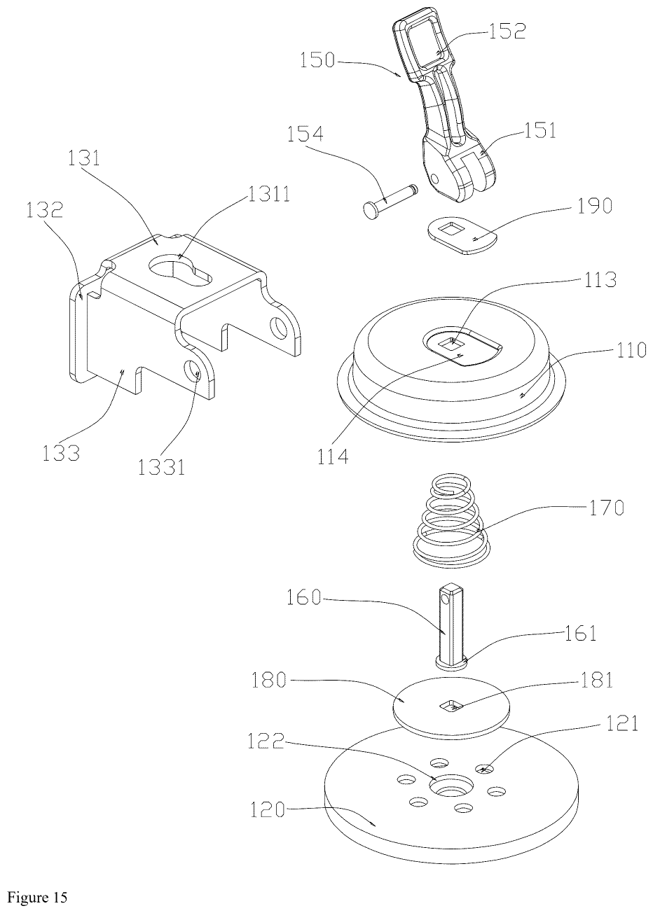

Referring to FIGS. 1 to 17, a floor moving system for moving floors is described. The upper surface of the floor is too rough for the suction cup to adhere. The system includes:

Tape 200, the lower surface of which is an adhesive surface for bonding to the upper surface of the floor, and the upper surface of which is a suction surface;

Suction device 100, which comprises a suction cup 120 that adheres to the upper surface of the tape 200, and when the suction device 100 is subjected to force, it drives the tape 200 and the floor bonded to the tape 200 to move.

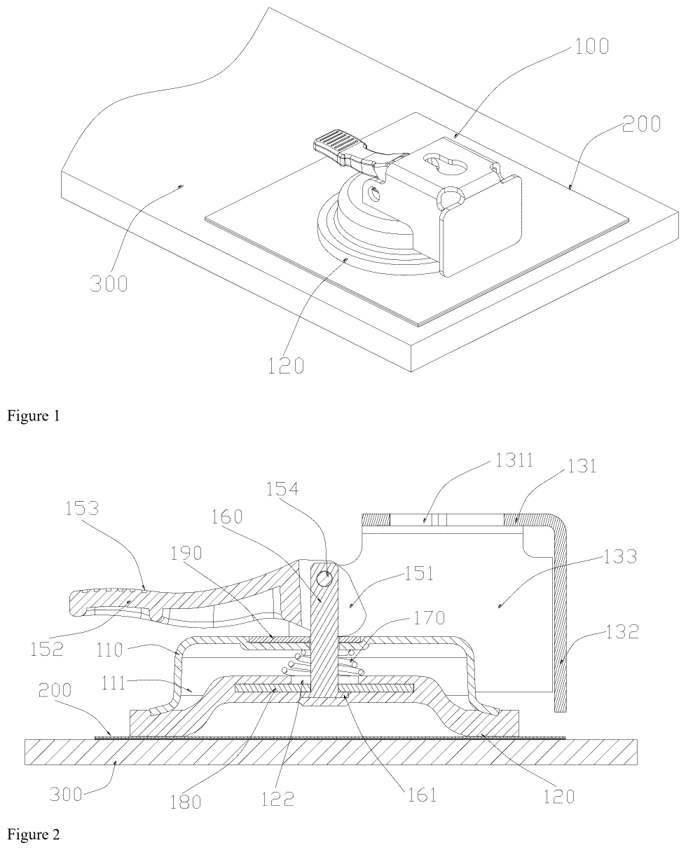

With the above structure, during use, the tape 200 is bonded to the upper surface of the floor, and then the suction cup 120 of the suction device 100 is adhered to the suction surface of the tape 200, as shown in FIGS. 1 and 2. By moving the suction device 100, the suction cup 120, tape 200, and the floor bonded to the tape 200 are moved, thereby allowing users to adjust the position of the floor and eliminate gaps between floor panels. The use of tape 200 can modify the floor surface, enabling users to employ a suction device 100 with a suction cup 120 to move the floor, thereby enhancing the adaptability of the suction device 100. It can be applied to floors with various surface characteristics, making it convenient for users to adjust the position of the floor. The system is simple to use.

In this embodiment, the tape 200 includes a substrate layer 210 and an adhesive layer 220, the adhesive layer 220 being connected to the lower surface of the substrate layer 210, the lower surface of the adhesive layer 220 being for bonding to the upper surface of the floor, the upper surface of the substrate layer 210 being the suction surface, and when the adhesive layer 220 is bonded to the upper surface of the floor and the suction device 100 is subjected to force to drive the tape 200 and the floor to move, the adhesive layer 220 has a peel strength sufficient to prevent the adhesive layer 220 from detaching from the floor surface. The adhesive layer 220 is connected to the lower surface of the substrate layer 210 to form the tape 200. During use, the lower surface of the adhesive layer 220 is bonded to the upper surface of the floor, and the suction cup 120 of the suction device 100 is adhered to the upper surface of the substrate layer 210. By moving the suction device 100, the suction device 100 drives the suction cup 120, tape 200, and the floor to move. The peel strength between the adhesive layer 220 and the floor surface prevents the adhesive layer 220 from detaching from the floor surface, ensuring that the tape 200 is stably bonded to the floor surface. This allows users to move the floor by moving the suction device 100, making it convenient to adjust the position of the floor and eliminate gaps between floor panels. The operation is simple.

In this embodiment, the adhesive layer 220 has a 90° peel strength of not less than 3800 gf/25 mm on stainless steel plates. The 90° peel strength of the adhesive layer 220 on stainless steel plates is not less than 3800 gf/25 mm, as measured according to ASTM D-3330, using Test Method F for single-faced tape. In this method, the adhesive item is bonded to a steel plate, and then the steel plate is moved at a specified rate while recording the average force required to peel the item from the steel plate. For example, according to the ASTM D-3330 standard test, a sample of tape 200 is adhered to a test steel plate, and the steel plate is fixed to the lower fixture of a tensile machine. The free end of the tape is vertically clamped into the upper fixture, ensuring a peel angle of 90±1. The peel speed is set at 300 mm/min. The tensile machine is started, and the force-displacement curve is recorded using the accompanying software of the tensile machine. The initial 40 mm and final 30 mm of data are discarded, and the average force value in the middle section is calculated. The sample of tape 200 is 25 mm wide and 300 mm long, with an effective peel length of >125 mm. The test results are shown in FIG. 4.

Furthermore, according to ASTM D-897 standard testing, the tensile strength of tape 200 on aluminum plates is not less than 4320 gf/cm²; according to ASTM D-3654 standard testing, the static hanging weight time on stainless steel plates at 80° C. is greater than 24 hours.

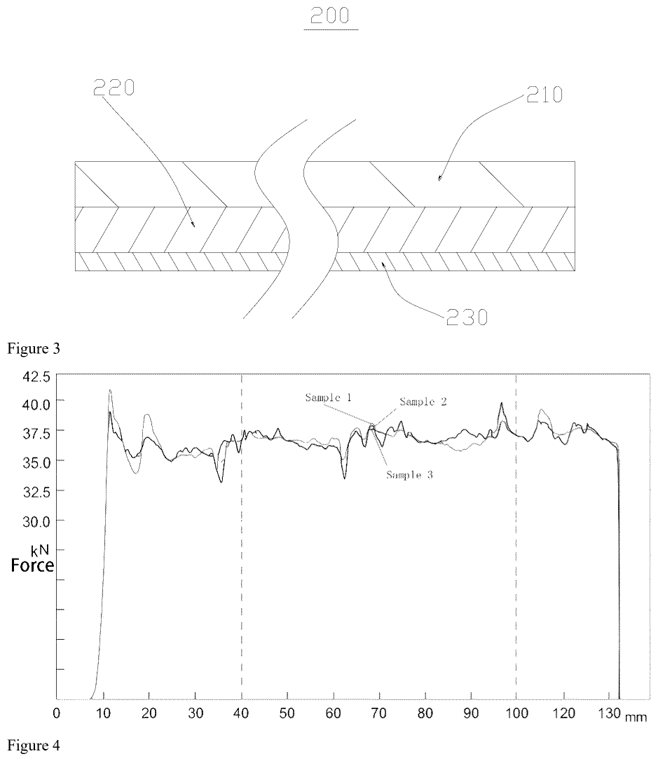

In this embodiment, the tape 200 also includes a release film 230. When the tape 200 is stored, the release film 230 covers the lower surface of the adhesive layer 220. The substrate layer 210 is an acrylic foam, the adhesive layer 220 is an acrylic adhesive layer, and the release film 230 is a PET film. During storage or transportation, as shown in FIG. 3, the release film 230 covers the lower surface of the adhesive layer 220, isolating the adhesive layer 220 from the external environment to prevent contamination by impurities. During use, the release film 230 is removed, and the lower surface of the adhesive layer 220 is bonded to the upper surface of the floor, ensuring a stable connection between the tape 200 and the floor. The suction cup 120 of the suction device 100 is then adhered to the upper surface of the substrate layer 210, allowing users to move the floor by moving the suction device 100.

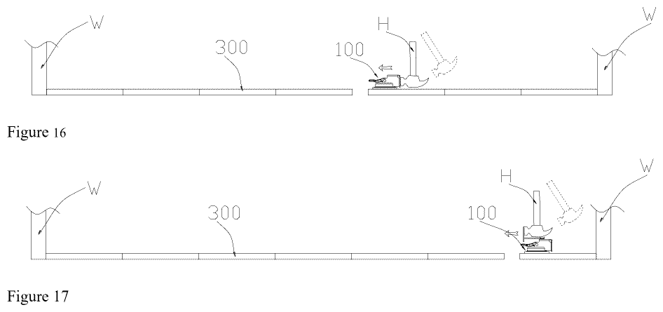

In this embodiment, the suction device 100 also includes a housing 110 and a striker 130. The housing 110 has a deformation chamber 111 and an opening 112. The opening 112 is in communication with the deformation chamber 111 and is oriented downward. The suction cup 120 is connected to the housing 110 and covers the opening 112. The striker 130 is connected to the housing 110 and is designed to allow users to strike it to move the floor adsorbed by the suction cup 120. With the above structure, during use, the tape 200 is bonded to the upper surface of the floor, and then the suction cup 120 is adhered to the tape 200. The edge of the opening 112 of the housing 110 is linked to the edge of the suction cup 120, ensuring that the edge of the suction cup 120 is on the same plane, thereby ensuring the stability of the suction cup structure. The deformation chamber 111 allows the upper part of the suction cup 120 to move upward to create a negative pressure between the suction cup 120 and the surface of the tape 200, enabling the suction cup 120 to more stably adhere to the surface of the tape 200. The striker 130 is connected to the housing 110, and users can strike the striker 130 with a hammer or other tools, thereby driving the housing 110, suction cup 120, tape 200 bonded to the suction cup 120, and the floor 300 to move. This makes it convenient for users to move the floor 300. Moreover, by adhering the suction cup 120 to the tape 200, the tape 200 uniformly connects to the floor, preventing damage to the floor during movement. Additionally, the striker 130 allows for more even force distribution, making it easier for users to move the floor in a specific direction. The product is more user-friendly, and it also prevents damage to the housing 110 that could affect the suction effect of the suction cup 120, thereby extending the product's service life. As shown in FIG. 16, users can strike the striker 130 with a hammer to move the floor in the direction of the arrow, adjusting the gaps between floor panels and the installation position of the floor.

In this embodiment, the striker 130 has a striking surface, which is designed to allow users to strike it. The normal to the striking surface is substantially perpendicular to the vertical axis of the housing 110. During use, when users strike the striking surface with a hammer or other tools, it provides an accurate target area for the user, making the operation more convenient and precise. Moreover, accurate striking of the surface ensures more even force distribution on the product, allowing users to move the floor in a specific direction and preventing the floor from shifting in other directions during the striking process. When users strike the striking surface, a force is applied to the striker 130 along its normal direction, driving the striker 130, housing 110, suction cup 120, tape 200, and the floor 300 bonded to the tape 200 to move in translation. This allows users to control the direction of movement of the floor 300, thereby precisely adjusting the position of the floor and improving the efficiency of floor installation and repair work.

In this embodiment, the striker 130 includes a main body 131, a striking part 132, and two connection parts 133. The two connection parts 133 are bent downward along the sides of the main body 131 and extend downward. The striking part 132 is bent downward along the rear side of the main body 131 and extends downward, with its inner surface abutting against the end surfaces of the two connection parts 133. The striker 130 is formed by bending a single piece of steel plate. Specifically, the two connection parts 133 are located on either side of the main body 131, and the striking part 132 is located at the rear side of the main body 131. The main body 131, striking part 132, and two connection parts 133 are different parts of the same steel plate. By bending the two connection parts 133 and the striking part 132 downward, the inner surface of the striking part 132 abuts against the end surfaces of the two connection parts 133, making the product structure more stable, as shown in FIG. 9. When users strike the striking part 132 with a hammer or other tools, the force applied to the striking part 132 is transmitted to the connection parts 133, and then to the housing 110, driving the suction cup 120, tape 200, and the floor 300 bonded to the tape 200 to move.

In this embodiment, the lower surface of the connection part 133 is at least partially connected to the upper surface of the housing 110, and the side of the connection part 133 opposite to the striking surface is connected to the side surface of the housing 110. With the above structure, the lower surface of the connection part 133 is connected to the upper surface of the housing 110, providing a larger contact area for stable connection between the connection part 133 and the housing 110. The side surface of the connection part 133 abuts against the side surface of the housing 110, allowing the force applied by the user on the striking part 132 to be stably and evenly transmitted to the housing 110. This makes the product structure more stable and extends its service life.

In this embodiment, the width of the striking part 132 is greater than the distance between the outer surfaces of the two connection parts 133. With the above structure, as shown in FIG. 9, the width of the striking part 132 is greater than the distance between the outer surfaces of the two connection parts 133, i.e., the side edges of the striking part 132 protrude beyond the outer surfaces of the connection parts 133. This ensures that the inner surface of the striking part 132 abuts against the ends of the two connection parts 133, allowing the force applied to the striking part 132 to be transmitted along the extension direction of the connection parts 133 to the housing 110. This enables users to move the floor in a specific direction by striking the striking part 132.

In this embodiment, the suction device 100 also includes an extension component 140, which includes an insertion block 141, a linkage rod 142, and a striking plate 143. The main body 131 has a through hole 1311. The insertion block 141 is inserted into the through hole 1311. The first end of the linkage rod 142 is connected to the insertion block 141, and the second end of the linkage rod 142 extends in a direction away from the striking part 132 and is connected to the striking plate 143. The striker 130 is designed to allow users to strike it. When moving a floor panel near a wall in a direction away from the wall, the space between the striking part 132 and the wall is very limited, making it difficult for users to swing a hammer or other striking tools. Therefore, the extension component 140 can be used. The insertion block 141 is inserted into the through hole 1311, and the second end of the linkage rod 142 extends away from the striking part 132, creating sufficient space between the striking plate 143 at the second end of the linkage rod 142 and the wall. This allows users to swing a hammer or other tools to strike the striking plate 143, as shown in FIG. 17, thereby moving the suction cup 120, tape 200, and floor 300, making it convenient for users to move floor panels near the wall.

In this embodiment, the second end of the linkage rod 142 is connected to the lower part of the striking plate 143, and the part of the striking plate 143 above the plane of the linkage rod 142 forms a striking area. With the above structure, the upper part of the striking plate 143 protrudes above the plane of the linkage rod 142, allowing users to more accurately and strike conveniently the striking plate 143 with a hammer or other tools, making the operation more user-friendly.

In this embodiment, the insertion block 141 includes an upper contact part 1411, a connection neck 1412, and a lower contact part 1413. The upper contact part 1411 and the lower contact part 1413 are connected to the upper and lower ends of the connection neck 1412, respectively. The diameters of the upper contact part 1411 and the lower contact part 1413 are greater than the diameter of the connection neck 1412. The upper contact part 1411 and the lower contact part 1413 are clamped on the upper and lower sides of the main body 131. With the above structure, during use, the insertion block 141 is inserted into the through hole 1311. At this time, the upper contact part 1411 and the lower contact part 1413 are clamped on the upper and lower sides of the main body 131, effectively connecting the insertion block 141 to the main body 131. This ensures a stable connection between the extension component 140 and the striker 130, allowing the force applied by the user on the striking plate 143 to be stably transmitted to the striker 130, and then to the housing 110 and suction cup 120, driving the floor 300 to move in a specific direction.

In this embodiment, the through hole 1311 is bulb-shaped, including an insertion area and a clamping area. The insertion area is located on the side of the clamping area away from the striking part 132. The diameter of the clamping area matches the diameter of the connection neck 1412, and the diameter of the insertion area is greater than the diameter of the lower contact part 1413. During use, the lower contact part 1413 is inserted along the insertion area, and then the insertion block 141 is moved horizontally to slide the connection neck 1412 into and clamp it in the clamping area. At this point, the upper contact part 1411 and the lower contact part 1413 are clamped on the upper and lower sides of the main body 131, achieving a stable connection between the insertion block 141 and the main body 131. This makes the installation convenient and the structure stable.

In this embodiment, the suction device 100 also includes an eccentric handle 150 and a pull column 160. The housing 110 has a through hole 113 in the middle. The lower end of the pull column 160 is connected to the suction cup 120, and the upper end of the pull column 160 protrudes through the through hole 113. The eccentric part 151 of the eccentric handle 150 is rotatably connected to the upper end of the pull column 160 and abuts against the housing 110. The pull column 160 drives the suction cup 120 to deform or reset. With the above structure, during use, the suction device is placed on the floor surface. The eccentric handle 150 is turned to the suction position, where the eccentric part 151 of the eccentric handle 150 pulls the pull column 160 upward, bringing the suction cup 120 connected to the lower end of the pull column 160 into a deformed state, as shown in FIG. 2. The negative pressure between the suction cup 120 and the tape 200 allows the suction cup 120 to stably adhere to the surface of the tape 200. Since the tape 200 is bonded to the floor surface, the operation is convenient. When removing the product, the eccentric handle 150 is turned in the opposite direction to drive the suction cup 120 to reset and detach from the surface of the tape 200.

In this embodiment, the suction device 100 also includes a reset spring 170. The reset spring 170 is sleeved on the pull column 160, and its upper and lower ends respectively abut against the lower surface of the housing 110 and the upper surface of the suction cup 120. The reset spring 170 gives the suction cup 120 a tendency to reset. With the above structure, the reset spring 170 is positioned on the pull column 160, and its upper and lower ends abut against the lower surface of the housing 110 and the upper surface of the suction cup 120. When the eccentric handle 150 is turned to the suction position, the reset spring 170 is compressed. When the eccentric handle 150 is released from the suction position, the reset spring 170 drives the eccentric handle 150 to move to the release position. The reset spring 170 ensures that the suction cup 120 remains in a flat, non-deformed state when the product is not adhered to the tape 200, preventing the suction cup 120 from aging. Moreover, the reset spring 170 sleeved on the pull column 160 confines the position of the reset spring 170, preventing it from shifting and ensuring the stability of the product.

In this embodiment, the suction device 100 also includes an installation plate 180. The suction cup 120 has an installation slot 121, and the installation plate 180 is inserted into the installation slot 121. The pull column 160 is connected to the installation plate 180. With the above structure, the installation plate 180 is inserted into the installation slot 121, and the lower end of the pull column 160 is connected to the installation plate 180. When the pull column 160 is pulled upward, the installation plate 180 drives the middle part of the suction cup 120 to move upward. The larger contact area between the installation plate 180 and the suction cup 120 ensures even force distribution across all parts of the suction cup, making the product structure more stable.

In this embodiment, the lower end of the pull column 160 has a protruding part 161. The installation plate 180 has a pull column hole 181. The upper end of the pull column 160 protrudes through the pull column hole 181, and the protruding part 161 abuts against the lower surface of the installation plate 180. With the above structure, the upper end of the pull column 160 is inserted along the pull column hole 181 and pulled upward until the protruding part 161 at the lower end of the pull column 160 abuts against the lower surface of the installation plate 180, ensuring a stable connection between the pull column 160 and the installation plate 180.

In this embodiment, the upper surface of the suction cup 120 also has an installation hole 122 that communicates with the installation slot 121. The diameter of the installation hole 122 is greater than that of the protruding part 161 and smaller than that of the installation plate 180. With the above structure, the diameter of the installation plate 180 is greater than that of the installation hole 122, allowing the installation plate 180 to be stably fixed in the installation slot 121. The diameter of the installation hole 122 is greater than that of the protruding part 161, allowing the protruding part 161 to be inserted along the installation hole 122.

In this embodiment, the reset spring 170 is a conical spring that is narrower at the top and wider at the bottom. The lower end of the reset spring 170 has a diameter smaller than that of the installation plate 180, and the lower end of the reset spring 170 abuts against the upper surface of the corresponding part of the suction cup 120. With the above structure, the conical spring has better lateral stability and a longer service life. It also saves installation space and has a higher load capacity.

In this embodiment, the product also includes a washer 190. The upper surface of the housing 110 has a washer groove 114, and the washer 190 is placed in the washer groove 114. The eccentric part 151 of the eccentric handle 150 abuts against the upper surface of the washer 190. With the above structure, the washer 190, usually made of steel, abuts against the upper surface of the eccentric part 151. The washer 190 evenly distributes the force applied by the eccentric part 151 to the housing 110, making the force distribution on the housing 110 more even and reducing the pressure on each part. Moreover, during the rotation of the eccentric part 151, it does not directly wear the surface of the housing 110 but instead rubs against the washer 190. When the washer 190 is worn out, it is convenient for users to replace it.

In this embodiment, the eccentric part 151 of the eccentric handle 150 is rotatably connected to the upper end of the pull column 160 via a pivot shaft 154. The striker 130 has an avoidance hole 1331, which is positioned opposite to the pivot shaft 154 to allow the pivot shaft 154 to pass through. With the above structure, during assembly, the pivot shaft 154 can pass through the avoidance hole 1331 to connect the eccentric part 151 of the eccentric handle 150 to the upper end of the pull column 160. The avoidance hole 1331 improves the assembly efficiency of the product.

In this embodiment, the handle part 152 of the eccentric handle 150 rotates between the suction position and the release position. When the handle part 152 is in the release position, its extension direction is substantially parallel to the vertical axis of the housing 110. When the handle part 152 is in the suction position, its extension direction is substantially perpendicular to the vertical axis of the housing 110, and the extension direction of the handle part 152 is away from the direction of the striker 130. When the handle part 152 is in the suction position, its extension direction is substantially the same as the normal direction, which allows it to avoid the extension component 140, making the installation of the extension component 140 more convenient.

In this embodiment, the surface of the handle part 152 has frictional texture 153. The frictional texture 153 allows users to more stably grasp the handle part 152 when turning the eccentric handle 150.

1. A floor moving system for moving floors, wherein the upper surface of the floor is too rough for the suction cup to adhere, characterized in that it includes:
Tape (200), the lower surface of which is an adhesive surface for bonding to the upper surface of the floor, and the upper surface of which is a suction surface;
Suction device (100), which comprises a suction cup (120) that adheres to the upper surface of the tape (200), and when the suction device (100) is subjected to force, it drives the tape (200) and the floor bonded to the tape (200) to move.

2. The floor moving system according to claim 1, characterized in that the tape (200) comprises a substrate layer (210) and an adhesive layer (220), the adhesive layer (220) being connected to the lower surface of the substrate layer (210), the lower surface of the adhesive layer (220) being for bonding to the upper surface of the floor, the upper surface of the substrate layer (210) being the suction surface, and when the adhesive layer (220) is bonded to the upper surface of the floor and the suction device (100) is subjected to force to drive the tape (200) and the floor to move, the adhesive layer (220) has a peel strength sufficient to prevent the adhesive layer (220) from detaching from the floor surface.

3. The floor moving system according to claim 2, characterized in that the adhesive layer (220) has a 90° peel strength of not less than 3800 gf/25 mm on stainless steel plates.

4. The floor moving system according to claim 2, characterized in that the tape (200) further comprises a release film (230), which covers the lower surface of the adhesive layer (220) when the tape (200) is stored, the substrate layer (210) being an acrylic foam, the adhesive layer (220) being an acrylic adhesive layer, and the release film (230) being a PET film.

5. The floor moving system according to claim 1, characterized in that the suction device (100) further comprises a housing (110) and a striker (130), the housing (110) having a deformation chamber (111) and an opening (112), the opening (112) being in communication with the deformation chamber (111) and oriented downward, the suction cup (120) being connected to the housing (110) and covering the opening (112), the striker (130) being connected to the housing (110), and the striker (130) being designed to allow users to strike it to drive the floor adsorbed by the suction cup (120) to move.

6. The floor moving system according to claim 5, characterized in that the striker (130) has a striking surface, which is designed to allow users to strike it, and the normal to the striking surface is substantially perpendicular to the vertical axis of the housing (110).

7. The floor moving system according to claim 6, characterized in that the striker (130) comprises a main body (131), a striking part (132), and two connection parts (133), the two connection parts (133) being bent downward along the sides of the main body (131) and extending downward, the striking part (132) being bent downward along the rear side of the main body (131) and extending downward, and the inner surface of the striking part (132) abutting against the end surfaces of the two connection parts (133).

8. The floor moving system according to claim 7, characterized in that the lower surface of the connection part (133) is at least partially connected to the upper surface of the housing (110), and the side of the connection part (133) opposite to the striking surface is connected to the side surface of the housing (110).

9. The floor moving system according to claim 7, characterized in that the width of the striking part (132) is greater than the distance between the outer surfaces of the two connection parts (133).

10. The floor moving system according to claim 7, characterized in that the suction device (100) further comprises an extension component (140), which includes an insertion block (141), a linkage rod (142), and a striking plate (143), the main body (131) having a through hole (1311), the insertion block (141) being inserted into the through hole (1311), the first end of the linkage rod (142) being connected to the insertion block (141), the second end of the linkage rod (142) extending in a direction away from the striking part (132) and being connected to the striking plate (143), and the striker (130) being designed to allow users to strike it.

11. The floor moving system according to claim 10, characterized in that the second end of the linkage rod (142) is connected to the lower part of the striking plate (143), and the part of the striking plate (143) above the plane of the linkage rod (142) forms a striking area.

12. The floor moving system according to claim 10, characterized in that the insertion block (141) comprises an upper contact part (1411), a connection neck (1412), and a lower contact part (1413), the upper contact part (1411) and the lower contact part (1413) being connected to the upper and lower ends of the connection neck (1412), respectively, the diameters of the upper contact part (1411) and the lower contact part (1413) being greater than the diameter of the connection neck (1412), and the upper contact part (1411) and the lower contact part (1413) being clamped on the upper and lower sides of the main body (131).

13. The floor moving system according to claim 12, characterized in that the through hole (1311) is bulb-shaped, including an insertion area and a clamping area, the insertion area being located on the side of the clamping area away from the striking part (132), the diameter of the clamping area matching the diameter of the connection neck (1412), and the diameter of the insertion area being greater than the diameter of the lower contact part (1413).

14. The floor moving system according to claim 5, characterized in that the suction device (100) further comprises an eccentric handle (150) and a pulling column (160), the housing (110) having a through hole (113) in the middle, the lower end of the pulling column (160) being connected to the suction cup (120), the upper end of the pulling column (160) protruding through the through hole (113), the eccentric part (151) of the eccentric handle (150) being rotatably connected to the upper end of the pulling column (160) and abutting against the housing (110), and driving the suction cup (120) to deform or reset through the pulling column (160).

15. The floor moving system according to claim 14, characterized in that the suction device (100) further comprises a reset spring (170), the reset spring (170) being sleeved on the pulling column (160), and its upper and lower ends respectively abutting against the lower surface of the housing (110) and the upper surface of the suction cup (120), the reset spring (170) enables the suction cup (120) to have a tendency to reset.

16. The floor moving system according to claim 15, characterized in that the suction device (100) further comprises a mounting plate (180), the suction cup (120) having a mounting slot (121), the mounting plate (180) being inserted into the mounting slot (121), and the pulling column (160) being connected to the mounting plate (180).

17. The floor moving system according to claim 16, characterized in that the lower end of the pulling column (160) has a protruding part (161), the mounting plate (180) has a pulling column hole (181), the upper end of the pulling column (160) protrudes through the pulling column hole (181), and the protruding part (161) abuts against the lower surface of the mounting plate (180).

18. The floor moving system according to claim 17, characterized in that the upper surface of the suction cup (120) also has a mounting hole (122) communicating with the mounting slot (121), the diameter of the mounting hole (122) being greater than the diameter of the protruding part (161) and smaller than the diameter of the mounting plate (180).

19. The floor moving system according to claim 16, characterized in that the reset spring (170) is a conical spring that is narrower at the top and wider at the bottom, the lower end of the reset spring (170) having a diameter smaller than that of the mounting plate (180), and the lower end of the reset spring (170) abutting against the upper surface of the corresponding part of the suction cup (120).

20. The floor moving system according to claim 14, characterized in that it further comprises a washer (190), the upper surface of the housing (110) having a washer groove (114), the washer (190) being placed in the washer groove (114), and the eccentric part (151) of the eccentric handle (150) abutting against the upper surface of the washer (190).
